(19) United States
(12) Patent Application Publication
(10) Pub. No.: US 2025/0289471 A1
(43) Pub. Date: Sep. 18, 2025

(54) Method and Device for Operating a Hands-off Driving Function of an Automated Motor Vehicle

(71) Applicant: Bayerische Motoren Werke Aktiengesellschaft, Muenchen (DE)

(72) Inventors: Hermann GRUENBERGER, Wolnzach (DE); Ralph Helmar RASSHOFER, Aichach (DE); Martin SEDLMAYR, Wessobrunn (DE); Hans-Joerg VOEGEL, Groebenzell (DE)

(21) Appl. No.: 18/860,053

(22) PCT Filed: Mar. 21, 2023
(86) PCT No.: PCT/EP2023/057144

§ 371 Date: Oct. 25, 2024

(30) Foreign Application Priority Data
Apr. 29, 2022 (DE) 10 2022 110 551.2

(51) Int. Cl. B60W 60/00; B60W 30/12; G06V 20/56

(52) U.S. Cl. CPC B60W 60/0015; B60W 30/12; G06V 20/588; B60W 2420/403; B60W 2520/105; B60W 2552/53

(57) ABSTRACT

A method for operating a hands-off driving function of an automated motor vehicle is provided. The method includes determining a first lane model based on image data of a camera which is installed on the automated motor vehicle and the field of view of which covers at least part of the surroundings of the automated motor vehicle, determining a trajectory of the automated motor vehicle based on the first lane model, and driving in an automated manner along the determined trajectory. The method also includes securing the automated driving, the lane model and/or the determined trajectory based on additional sensor data.

### BACKGROUND AND SUMMARY

The present disclosure relates to a method for operating a hands-off driving function of an automated motor vehicle and a data processing device designed to at least partially carry out the method. Furthermore, an automated motor vehicle having the data processing device is provided. Additionally or alternatively, a computer program is provided comprising commands which, upon the execution of the program by a computer, prompt it to at least partially carry out the method. Additionally or alternatively, a non-transitory computer-readable medium is provided comprising commands which, upon the execution of the commands by a computer, prompt it to at least partially carry out the method.

A degree of automation is increasing in modern motor vehicles, in particular automobiles. More and more driving tasks are taken over by the motor vehicle itself, i.e., the motor vehicles have driver assistance systems which enable at least semiautomated driving.

One of these functions is taking over the lateral and longitudinal control of the motor vehicle without the driver having to have their hands on the steering wheel, i.e., a hands-off function. This function is presently only activatable in predetermined driving situations, in particular on highways having structurally separated directions of travel, i.e., separate lanes in each direction of travel, wherein the separation is produced by a guide rail. This currently permits the activation of the automated driving function up to a predetermined speed limit value, which is presently 60 km/h.

One disadvantage or one limitation of the prior art is the restricted number of driving situations in which the automated driving function is activatable.

Against the background of this prior art, the object of the present disclosure is to specify a device and a method, which are each suitable for overcoming at least the above-mentioned disadvantage of the prior art.

The object is achieved by the features of the independent claims. Refinements of the disclosure are the subject of the dependent and subclaims.

The object is accordingly achieved by a method for operating a hands-off driving function of an automated motor vehicle.

The motor vehicle can be a non-railbound vehicle, such as a passenger vehicle or an automobile.

The method can be a computer-implemented method, i.e., one, multiple, or all steps of the method can be carried out by a data processing device.

A hands-off driving function can be understood as a driving function or an activatable state, in which the motor vehicle takes over a lateral guidance and/or a longitudinal guidance of the motor vehicle in an automated manner, without a driver or user of the motor vehicle having to have his hands on the steering wheel.

The method comprises determining a first lane model based on image data of a camera installed on the automated motor vehicle, the field of view of which covers at least a part of the surroundings of the automated motor vehicle.

A lane model can be understood as a digital model of a part of the surroundings of the motor vehicle which has information about a location and/or a course of one or more lanes in the surroundings of the motor vehicle. The lane model can be part of a surroundings model, which has further information about objects in the surroundings of the motor vehicle.

The method furthermore comprises determining a trajectory of the automated motor vehicle based on the first lane model and automated driving along the determined trajectory.

A trajectory can be understood as a path which the motor vehicle follows in an automated manner, i.e., by a control of a lateral and/or longitudinal guidance of the motor vehicle. In addition to location information, the trajectory can have a time component, i.e., when the motor vehicle is to be where. The trajectory comprises, possibly among other things, future positions of the motor vehicle.

The method is distinguished in that the method comprises safeguarding the automated driving, the lane model, and/or the determined trajectory on the basis of further sensor data.

That is to say, in order to overcome the above-described disadvantage of the prior art, in which an activation of the hands-off driving function is exclusively possible in the case of structural separation of the directions of travel, the automated driving, the lane model, and/or the determined trajectory are safeguarded by the motor vehicle itself. This is carried out on the basis of sensor data of at least one sensor, which is different from the camera that supplies the image data for the first lane model. The physical fallback level “guide rail” can thus be converted into a digital fallback level or replaced thereby, so that the hands-off driving function can also be operated in driving situations in which no structural separation of the directions of travel is present, for example, on highways having median strips between the directions of travel.

Refinements of the above-described method are set forth in detail hereinafter.

The safeguarding of the automated driving can include detecting a lane departure of the automated motor vehicle based on the further sensor data.

The detection of the lane departure can take place based on vibrations in a chassis of the automated motor vehicle and/or interior acoustics of the automated motor vehicle.

The safeguarding of the automated driving can include monitoring an acceleration of the motor vehicle.

The safeguarding of the first lane model and/or the determined trajectory can include determining a second lane model based on the further sensor data.

The safeguarding of the lane model and/or the determined trajectory can include a plausibility check in which the first lane model is checked for plausibility on the basis of the second lane model.

The description above can be summarized as follows and with reference to a specific embodiment, which is described as not limiting for the present disclosure: In the field of driver assistance, a lane departure warning, lane keeping systems, and automated driving functions are known. In particular in the case of a highway having structurally separated directions of travel (i.e., separate lanes in each direction, separation by median strips and guide rail(s)), an automated driving function, the so-called commute pilot up to 60 km/h (CP60), currently permits hands-off driving. Presently, exclusively a center guide rail is used as a fallback level, which prevents a deviation onto the opposite roadway and a possible collision thus caused with the oncoming traffic. A route enabling of the highway pilot for sections with structurally separated directions of travel but without guide rails (i.e., only median strips), in particular as a protection from swerving into the oncoming traffic, requires an additional measure to reliably prevent swerving into the oncoming traffic (or to detect the roadway departure with possible emergency stop). This requires robust sensing and detection of the roadway departure. In principle, various sensors can be observed for a fallback level (in particular camera-based lateral guidance, as well as acoustics and acceleration/movement). The focus of the novel concept according to the disclosure is a combination of correlated/complementary sensors for robust sensing and handling of the technology (weaknesses) for roadway departure. Wheel acceleration/level measurement sensors, steering forces, coefficient of friction/wheel speed sensors, vertical acceleration, lateral acceleration/yaw rate in the sense of comparison/plausibility check to the single-lane model can be used. Additionally or alternatively, driving-acoustics deviations/events and/or optical approaches can be used to detect non-roadway situations. In particular, detection via multi-sensor fusion with trained machine learning model is conceivable, wherein multi-sensor fusion can be understood as a combination of camera-based sensors (for conventional lane keeping systems) with fallback/supplementation level from vertical dynamics (path, acceleration), from a 6DoF sensor cluster (abbrev. for six degrees of freedom: acceleration in X, Y, and Z as well as yawing, pitching, tilting) and/or acoustics.

Furthermore, a computer program is provided, comprising commands which, upon the execution of the program by a computer prompt it to at least partially execute or carry out the above-described method.

A program code of the computer program can be present in any arbitrary code, in particular in a code which is suitable for a control of motor vehicles.

The description above with reference to the method also applies analogously to the computer program and vice versa.

Furthermore, a data processing device, such as a control unit, for an automated motor vehicle is provided, wherein the data processing device is configured to at least partially execute or carry out the above-described method.

The data processing device can be part of a driver assistance system or can represent it. The data processing device can be, for example, an electronic control unit (ECU). The electronic control unit can be an intelligent processor-controlled unit which can communicate, for example, via a central gateway (CGW) with other modules and can form the vehicle onboard network, possibly via field buses, such as the CAN bus, LIN bus, MOST bus, and/or FlexRay or via automotive ethernet, for example, together with telematics control units. It is conceivable that the control unit controls functions relevant for the driving behavior of the motor vehicle, such as the motor control, the force transmission, the braking system, and/or the tire pressure monitoring system. In addition, driver assistance systems, such as a parking assistant, an adaptive cruise control (ACC), a lane keeping assistant, a lane changing assistant, a traffic sign detector, a traffic signal detector, a startup assistant, a night view assistant, and/or an intersection assistant can be controlled by the control unit. In particular, the electronic control unit can be designed to take over the lateral and/or longitudinal guidance of the motor vehicle in the scope of the above-described method at least partially and/or temporarily.

The description above with reference to the method and to the computer program also applies analogously to the data processing device and vice versa.

Furthermore, an automated motor vehicle comprising the above-described data processing device is provided.

The motor vehicle can be a passenger vehicle, in particular an automobile. The automated motor vehicle can be designed to at least partially and/or at least temporarily take over a longitudinal guidance and/or a lateral guidance during automated driving of the motor vehicle, in particular by means of the data processing device. The automated driving can take place so that the forward movement of the motor vehicle takes place (largely) autonomously. The automated driving can be controlled at least partially and/or temporarily by the data processing device.

The motor vehicle can be a motor vehicle of autonomy level 2 to 5. That is to say:

The motor vehicle can be a motor vehicle of autonomy level 2, i.e., partially automated so that functions such as automatic parking, lane keeping or lateral guidance, general longitudinal guidance, acceleration, and/or deceleration can at least partially be taken over by driver assistance systems.

The motor vehicle can be a motor vehicle of autonomy level 3, i.e., conditionally automated so that the driver does not have to continuously monitor the system of the motor vehicle. The motor vehicle independently carries out functions such as triggering the turn signal, lane changing, and/or lane keeping. The driver can address other things but will be prompted by the system if needed within a prewarning time to take over the control.

The motor vehicle can be a motor vehicle of autonomy level 4, i.e., so highly automated that the control of the vehicle is permanently taken over by the system of the vehicle. If the driving tasks are no longer managed by the system, the driver can be prompted to take over the control.

The motor vehicle can be a motor vehicle of autonomy level 5, i.e., so fully automated that the driver is not necessary to fulfill the driving task. Except for defining the destination and starting the system, no human intervention is necessary. The motor vehicle can manage without steering wheel and pedals.

The description above with reference to the method, the data processing device, and the computer program also applies analogously to the motor vehicle and vice versa.

Furthermore, a non-transitory computer-readable medium is provided, in particular a computer-readable storage medium. The computer-readable medium comprises commands which, upon the execution of the program by a computer, prompt it to at least partially execute the above-described method.

That is to say, a computer-readable medium can be provided which comprises an above-described computer program. The computer-readable medium can be any digital data storage device, such as a USB stick, a hard drive, a CD-ROM, an SD card, or an SSD card. The computer program does not necessarily have to be stored on such a computer-readable storage medium in order to be provided to the motor vehicle, but rather can also be externally acquired via the Internet or in another way.

The description above with respect to the method, the data processing device, the computer program, and the automated motor vehicle also applies analogously to the computer-readable medium and vice versa.

An embodiment is described hereinafter with reference to FIGS. 1 and 2.

### BRIEF DESCRIPTION OF THE DRAWINGS

FIG. 1 schematically shows an automated motor vehicle, comprising a data processing device configured to carry out a method for operating a hands-off driving function of an automated motor vehicle, and

FIG. 2 schematically shows a flow chart of the method for operating the hands-off driving function of the automated motor vehicle.

### DETAILED DESCRIPTION OF THE DRAWINGS

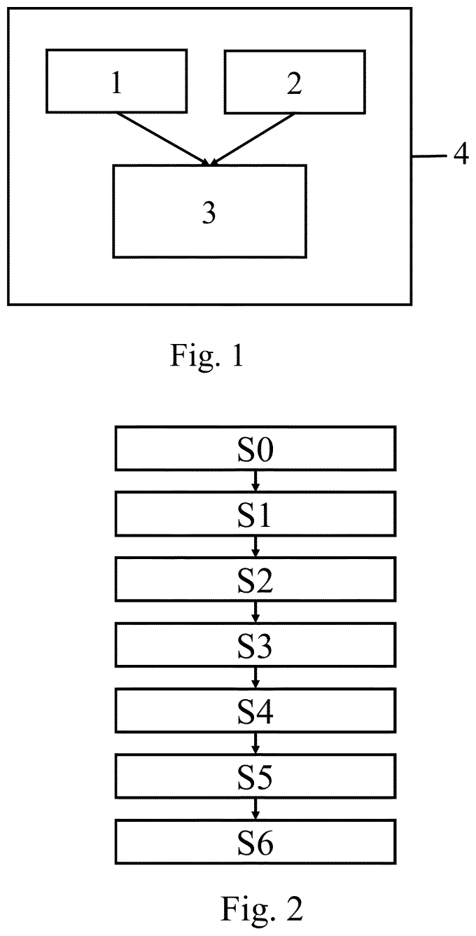

The automated motor vehicle 4 shown in FIG. 1 has a camera 1 and a sensor system 2. The camera 1 and the sensor system 2 are each connected to a data processing device 3 of the motor vehicle 4. The camera 1 is designed or configured to record image data and output these data to the data processing device 3, wherein the field of view of the camera 1 covers at least a part of the surroundings of the automated motor vehicle 4, which is located in particular in front of and adjacent to the motor vehicle 4. The sensor system 2 is designed to acquire (low-frequency) vibrations in a chassis (not shown) of the automated motor vehicle 4, interior acoustics of the motor vehicle 4 (i.e., high-frequency vibrations in the vehicle interior), an acceleration of the motor vehicle 4 (in particular 6DoF, as described above), and, by means of a radar, LiDAR, and/or ultrasonic sensor, sensor data which correspond to the surroundings of the motor vehicle 4 and output these data as so-called further sensor data to the data processing device 3. The data processing device 3 is designed to execute the method described hereinafter with reference to FIG. 2 for operating a hands-off driving function of the automated motor vehicle 4 based on the received image data and the further sensor data.

In a first step S1 of the method, the data processing device 3 determines a first lane model based on image data of the camera 1 installed on the automated motor vehicle 4.

In a second step S2 of the method, the data processing device 3 safeguards the first lane model on the basis of the further sensor data received from the sensor system 2, in particular on the basis of the sensor data of the radar, LiDAR, and/or ultrasonic sensor. For this purpose, the data processing device 3 determines a second lane model based on the further sensor data and compares it to the first lane model to check the plausibility.

In a third step S3 of the method, the data processing device 3 determines a first trajectory of the automated motor vehicle 4 based on the first lane model.

In a fourth step S4 of the method, the data processing device 3 safeguards the first trajectory. For this purpose, the data processing device 3 determines a second trajectory based on the second lane model and compares it to the first trajectory to check the plausibility.

In a fifth step S5 of the method, automated driving controlled by the data processing device 3 takes place along the safeguarded first trajectory.

In a sixth step S6 of the method, the data processing device 3 safeguards the automated driving on the basis of the further sensor data. The safeguarding of the automated driving comprises detecting a lane departure of the automated motor vehicle 4 based on the further sensor data, in particular based on the vibrations in the chassis of the automated motor vehicle 4 and/or the interior acoustics of the automated motor vehicle 4, as well as monitoring the acceleration of the automated motor vehicle 4.

If a deviation from target to actual is established in at least one of the safeguarding steps, i.e., in steps S2, S4, and S6, which exceeds a predetermined limiting value, the data processing device 3 suppresses the hands-off driving function, i.e., no automated driving as described with reference to the fifth step S5 takes place and/or alleviating measures are initiated, such as emergency braking.

Furthermore, the method can have a further initial step S0, which includes a determination of the presence of a predetermined driving situation in which a hands-off driving function is activatable. It can also be established whether an execution of the above-described method is necessary in this established driving situation. It is thus conceivable that the method is only executed when the driving situation requires it, i.e., for example, when no guard rail(s) is or are present between the lanes of different directions of travel. Computing power can thus be saved in driving situations in which the first lane model for operating the hands-off driving function offers sufficient safety. Map data can be used to determine the current driving situation, for example. Initial step S0 can also be executed by the data processing device 3.

The above-described method steps can, but do not have to, be executed in the above-described order. Rather, they can also be executed in an order other than that described and can at least partially overlap.

### LIST OF REFERENCE SIGNS

1 camera
2 sensor system
3 data processing device
4 motor vehicle
S0-S6 method steps

1.-10. (canceled)

11. A method for operating a hands-off driving function of an automated motor vehicle, the method comprising:
determining a first lane model based on image data of a camera installed on the automated motor vehicle, a field of view of which covers at least a part of surroundings of the automated motor vehicle;
determining a trajectory of the automated motor vehicle based on the first lane model;
controlling automated driving along the determined trajectory; and
safeguarding the automated driving, the first lane model, and/or the determined trajectory based on sensor data.

12. The method according to claim 11, wherein the safeguarding of the automated driving includes detecting a lane departure of the automated motor vehicle based on the sensor data.

13. The method according to claim 12, wherein the lane departure is detected based on vibrations in a chassis of the automated motor vehicle and/or interior acoustics of the automated motor vehicle.

14. The method according to claim 11, wherein the safeguarding of the automated driving includes monitoring an acceleration of the automated motor vehicle.

15. The method according to claim 12, wherein the safeguarding of the automated driving includes monitoring an acceleration of the automated motor vehicle.

16. The method according to claim 13, wherein the safeguarding of the automated driving includes monitoring an acceleration of the automated motor vehicle.

17. The method according to claim 11, wherein the safeguarding of the first lane model and/or the determined trajectory includes determining a second lane model based on the sensor data.

18. The method according to claim 12, wherein the safeguarding of the first lane model and/or the determined trajectory includes determining a second lane model based on the sensor data.

19. The method according to claim 13, wherein the safeguarding of the first lane model and/or the determined trajectory includes determining a second lane model based on the sensor data.

20. The method according to claim 17, wherein the safeguarding of the first lane model and/or the determined trajectory includes a plausibility check in which the first lane model is checked for plausibility based on the second lane model.

21. A non-transitory computer-readable medium storing commands which, upon execution of the commands by a computer, prompt the computer to carry out a method comprising:
determining a first lane model based on image data of a camera installed on the automated motor vehicle, a field of view of which covers at least a part of surroundings of the automated motor vehicle;
determining a trajectory of the automated motor vehicle based on the first lane model;
controlling automated driving along the determined trajectory; and
safeguarding the automated driving, the first lane model, and/or the determined trajectory based on sensor data.

22. The non-transitory computer-readable medium according to claim 21, wherein the safeguarding of the automated driving includes detecting a lane departure of the automated motor vehicle based on the sensor data.

23. The non-transitory computer-readable medium according to claim 22, wherein the lane departure is detected based on vibrations in a chassis of the automated motor vehicle and/or interior acoustics of the automated motor vehicle.

24. The non-transitory computer-readable medium according to claim 21, wherein the safeguarding of the automated driving includes monitoring an acceleration of the automated motor vehicle.

25. The non-transitory computer-readable medium according to claim 21, wherein the safeguarding of the first lane model and/or the determined trajectory includes determining a second lane model based on the sensor data.

26. A data processing device for an automated motor vehicle, wherein the data processing device is configured to carry out a method comprising:
determining a first lane model based on image data of a camera installed on the automated motor vehicle, a field of view of which covers at least a part of surroundings of the automated motor vehicle;
determining a trajectory of the automated motor vehicle based on the first lane model;
controlling automated driving along the determined trajectory; and
safeguarding the automated driving, the first lane model, and/or the determined trajectory based on sensor data.

27. The data processing device according to claim 26, wherein the safeguarding of the automated driving includes detecting a lane departure of the automated motor vehicle based on the sensor data.

28. The data processing device according to claim 27, wherein the lane departure is detected based on vibrations in a chassis of the automated motor vehicle and/or interior acoustics of the automated motor vehicle.

29. The data processing device according to claim 26, wherein the safeguarding of the automated driving includes monitoring an acceleration of the automated motor vehicle.

30. An automated motor vehicle comprising the data processing device according to claim 26.
